(19) United States
(12) Patent Application Publication
(10) Pub. No.: US 2013/0016521 A1
(43) Pub. Date: Jan. 17, 2013

(54) BACKLIGHT UNIT AND DISPLAY APPARATUS USING THE SAME

(71) Applicants: Sang Hyeok Jung, Seoul (KR); Moon Jeong Kim, Seoul (KR); Jeong Hwan Kim, Seoul (KR)

(72) Inventors: Sang Hyeok Jung, Seoul (KR); Moon Jeong Kim, Seoul (KR); Jeong Hwan Kim, Seoul (KR)

(21) Appl. No.: 13/400,943

(22) Filed: Feb. 21, 2012

(30) Foreign Application Priority Data
Jul. 15, 2011 (KR) 10-2011-0070376

(51) Int. Cl. G09F 13/18

(52) U.S. Cl. 362/602

(57) ABSTRACT

Disclosed are a backlight unit and a display apparatus using the same. The backlight unit includes a light guide plate including first and second grooves, and light source modules disposed within the second grooves. The first grooves are disposed on the upper surface of the light guide plate, and the second grooves are disposed on the lower surface of the light guide plate, and the first grooves are disposed between light sources of the light source module.

### CROSS REFERENCE TO RELATED APPLICATION

This application claims priority under 35 U.S.C. §119 to Korean Patent Application No. 10-2011-0070376, filed in Korea on Jul. 15, 2011 which is hereby incorporated in its entirety by reference as if fully set forth herein.

### TECHNICAL FIELD

Embodiments relate to a backlight unit and a display apparatus using the same.

### BACKGROUND

In general, as a representative large-scale display apparatus, a liquid crystal display (LCD) or a plasma display panel (PDP) is used.

Differently from the PDP of a self-emitting type, the LCD essentially requires a separate backlight unit due to absence of self-emitting light emitting devices.

Backlight units used in LCDs are divided into an edge type backlight unit and a direct type backlight unit according to positions of light sources. In the edge type backlight unit, light sources are disposed on side surfaces of an LCD panel and a light guide plate is used to uniformly distribute light throughout the overall surface of the LCD panel, and thus uniformity of light is improved and the panel has an ultra-thin thickness.

In the direct type backlight unit which is generally used in displays having a size of 20 inches or more, a plurality of light sources is disposed under a panel. Thus, the direct type backlight unit has excellent optical efficiency, as compared to the edge type backlight unit, thereby being mainly used in large-scale displays requiring high brightness.

As light sources of the conventional edge type or direct type backlight unit, cold cathode fluorescent lamps (CCFLs) are used.

However, a backlight unit using CCFLs may consume a considerable amount of power because power is applied to the CCFLs at all times, exhibit a color reproduction rate of about 70% that of a CRT, and cause environmental pollution due to addition of mercury.

In order to solve these problems, research into a backlight unit using light emitting diodes (LEDs) has been conducted now.

If LEDs are used as the backlight unit, an LED array may be partially turned on/off and thus power consumption may be considerably reduced. Particularly, RGB LEDs exceed 100% of national television system committee (NTSC) color reproduction range specifications, thus providing a more vivid image to consumers.

### SUMMARY

Embodiments provide a backlight unit which forms grooves at designated areas of the upper surface of a light guide plate to reduce dark regions, and a display apparatus using the same.

In one embodiment, a backlight unit includes a light guide plate including first and second grooves, and light source modules disposed within the second grooves, wherein the first grooves are disposed on the upper surface of the light guide plate, and the second grooves are disposed on the lower surface of the light guide plate, and the first grooves are disposed between light sources of the light source module.

One side end of each of the first grooves may be disposed on an extension line extending from the side surface of each of the second grooves, or be separated from the extension line extending from the side surface of each of the second grooves by a designated interval.

The first grooves and the second grooves may partially overlap with each other.

The cross-section of each of the first grooves may include a first inclined surface and a second inclined surface meeting at one point. The first inclined surface may be a concave surface having a first curvature, the second inclined surface may be a concave surface having a second curvature, and the first curvature and the second curvature may be different.

The first inclined surface may be a flat surface inclined at a first angle with respect to the upper surface of the light guide plate, the second inclined surface may be a flat surface inclined at a second angle with respect to the upper surface of the light guide plate, and the first angle and the second angle may be different.

One of the first and second inclined surfaces may be a concave surface having a designated curvature, and the other of the first and second inclined surfaces may be a flat surface inclined at a designated angle with respect to the upper surface of the light guide plate.

Otherwise, the cross-section of each of the first grooves may include a first inclined surface and a second inclined surface, and a flat surface parallel with the upper surface of the light guide plate may be disposed between the first and second inclined surfaces.

The first grooves may have a height of 0.1˜0.5 mm, and the maximum depth of the first grooves may be smaller than a distance from the upper surface of the light guide plate to the second grooves.

The length of the first grooves may be a distance between both ends of the first grooves disposed in a first direction, the width of the first grooves may be a distance between both ends of the first grooves disposed in a second direction perpendicular to the first direction, and the length and width of the first grooves may be smaller than a distance between the light sources of the light source module.

Here, the length of the first grooves may be 3˜7 mm, and the width of the first grooves may be 1˜4 mm.

The light guide plate may further include third grooves disposed between the adjacent first grooves, and the third grooves may be disposed corresponding to the respective light sources of the light source module.

The length and width of the third grooves may be smaller than the length and width of the first grooves, the depth of the third grooves may be smaller than the depth of the first grooves, and a ratio of the depth of the third grooves to the depth of the first grooves may be 1:1.5˜3.

Each of the third grooves may be separated from one side of each of the second grooves by a designated interval, and the length of the third grooves may be greater than the length of the respective light sources of the light source module.

### BRIEF DESCRIPTION OF THE DRAWINGS

Arrangements and embodiments may be described in detail with reference to the following drawings in which like reference numerals refer to like elements and wherein:

FIG. 1 is a cross-sectional view illustrating a backlight unit in accordance with one embodiment;

FIG. 2 is a cross-sectional view illustrating a position at which a first groove of a light guide plate is disposed;

FIG. 3A to 3C are cross-sectional views illustrating position relations between first grooves and second grooves of the light guide plate;

FIGS. 4A to 4E are cross-sectional views illustrating various shapes of first grooves of the light guide plate;

FIG. 5 is a plan view illustrating the positions of the first grooves of the light guide plate;

FIG. 6 is a plan view illustrating the positions of third grooves of the light guide plate;

FIGS. 7A and 7B are views illustrating refraction of light according to presence and absence of the first groove of the light guide plate;

FIG. 8 is a cross-sectional view illustrating a display module having a backlight unit in accordance with one embodiment; and

FIGS. 9 and 10 are views respectively illustrating display apparatuses in accordance with embodiments.

### DESCRIPTION OF SPECIFIC EMBODIMENTS

Hereinafter, embodiments will be described with reference to the annexed drawings.

It will be understood that when an element is referred to as being “on” or “under” another element, it can be directly on/under the element, and one or more intervening elements may also be present.

When an element is referred to as being “on” or “under”, “under the element” as well as “on the element” can be included based on the element.

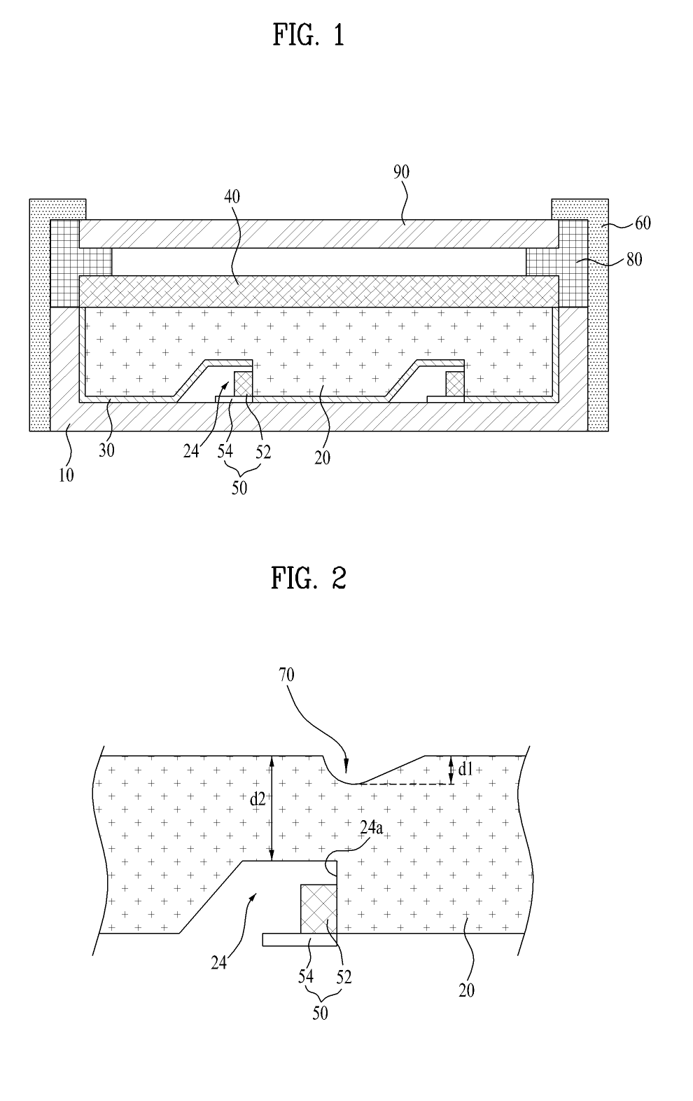

FIG. 1 is a cross-sectional view illustrating a backlight unit in accordance with one embodiment.

As shown in FIG. 1, the backlight unit includes a light guide plate 20 having first and second grooves 70 and 24, a reflector 30, optical member 40, and light source modules 50.

The backlight unit may further include a top chassis 60, a bottom chassis 10, and a panel guide module 80.

Here, the panel guide module 80 may support a display panel 90, and the top chassis 60 may be connected to the panel guide module 80 and the bottom chassis 10.

At least one first groove 70 may be disposed on the upper surface of the light guide plate 20, and at least one second groove 24 may be disposed on the lower surface of the light guide plate 20.

Here, the first groove 70 of the light guide plate 20 may have a hemispheric, triangular, or trapezoidal cross-section.

That is, the cross-section of the first groove 70 may include a first inclined surface and a second inclined surface meeting at one point. The first inclined surface may be a concave surface having a first curvature, the second inclined surface may be a concave surface having a second curvature, and the first curvature and the second curvature may be different.

According to circumstance, the first inclined surface may be a flat surface inclined at a first angle with respect to the upper surface of the light guide plate 20, the second inclined surface may be a flat surface inclined at a second angle with respect to the upper surface of the light guide plate 20, and the first angle and the second angle may be different.

Further, one of the first and second inclined surfaces may be a concave surface having a designated curvature, and the other of the first and second inclined surfaces may be a flat surface inclined at a designated angle with respect to the upper surface of the light guide plate 20.

As an another example, the cross-section of the first groove 70 may include a first inclined surface and a second inclined surface, and a flat surface parallel with the upper surface of the light guide plate 20 may be disposed between the first and second inclined surfaces.

The first groove 70 having the above shape may be disposed at one side of the second groove 24, and may be disposed between light sources 52 of the light source module 50.

Here, the first groove 70 may have a depth of about 0.1˜0.5 mm, and the maximum depth value of the first groove 70 may be smaller than a distance value between the upper surface of the light guide plate 20 and the second groove 24.

The length of the first groove 70 means a distance between both ends of the first groove 70 disposed in a first direction, the width of the first groove 70 means a distance between both ends of the first groove 70 in a second direction perpendicular to the first direction, and the length and width of the first groove 70 may be smaller than the distance between the light sources 52 of the light source module 50.

Here, the length of the first groove 70 may be about 3˜7 mm, and the width of the first groove 70 may be about 1˜4 mm.

The second groove 24 disposed on the lower surface of the light guide plate 20 may have a triangular, rectangular or trapezoidal cross-section.

If the second groove 24 of the light guide plate 20 has a trapezoidal cross-section, from among a first side surface and a second side surface of the second groove 24 opposite each other, the first side surface of the second groove 24 may be perpendicular to the bottom surface of the second groove 24, and the second side surface of the second groove 24 may be inclined at a first angle with respect to the bottom surface of the second groove 24.

Otherwise, if the second groove 24 of the light guide plate 20 has a trapezoidal cross-section, the first and second side surfaces of the second groove 24 opposite each other may be inclined with respect to the bottom surface of the second groove 24, and an angle between the first side surface and the bottom surface of the second groove 24 may be smaller than an angle between the second side surface and the bottom surface of the second groove 24.

Further, if the second groove 24 of the light guide plate 20 has a triangular cross-section, an angle between first and second side surfaces opposite each other of the second groove 24 may be about 30° to 120°.

Further, a ratio of the height of the second groove 24 of the light guide plate 20 to the overall thickness of the light guide plate 20 may be about 0.3˜0.7:1.

The light guide plate 20 may be formed of at least one selected from among the group consisting of acrylic resins, such as polymethylmethacrylate (PMMA), polyethylene terephthalate (PET), cyclic olefin copolymers (COCs), polyethylene naphthalate (PEN), polycarbonate (PC), polystyrene (PS) and methacrylate styrene (MS) resins.

The light source modules 50 may be disposed within the second grooves 24 of the light guide plate 20.

Here, each light source module 50 may include a substrate 54 and at least one light source 52 disposed on the substrate 54. Both the substrate 54 and the at least one light source 52 may be disposed within the second groove 24 of the light guide plate 20.

According to circumstance, the substrate 54 may be disposed at the outside of the second groove 24 of the light guide plate 20, and the at least one light source 52 may be disposed within the second groove 24 of the light guide plate 20.

The substrate 54 may include an electrode pattern to be electrically connected to the light source 52, and may be a printed circuit board (PCB) formed of at least one selected from the group consisting of polyethylene terephthalate (PET), glass, polycarbonate (PC) and silicon (Si), or be formed as a film.

Further, the substrate 54 may selectively employ a single layer PCB, a multi-layer PCB, a ceramic substrate, a metal core PCB, etc.

The at least one light source 52 may be disposed on the substrate 54, and the light source 52 may be a side view type LED.

According to circumstance, the light source 52 may be a top view type LED.

As described above, the light source 52 may be an LED chip, and the LED chip may be a blue LED chip or an ultraviolet LED chip, or a package in which at least one of a red LED chip, a green LED chip, a blue LED chip, a yellow green LED chip and a white LED chip are combined.

Here, the white LED may be produced by combining a yellow phosphor with a blue LED, by using both a red phosphor and a green phosphor on a blue LED, or by using a yellow phosphor, a red phosphor and a green phosphor on a blue LED.

The reflector 30 may be disposed on the lower surface of the light guide plate 20.

That is, the reflector 30 may be disposed between the light guide plate 20 and the bottom chassis 10, and may extend from the lower surface to the side surface of the light guide plate 20.

Here, the reflector 30 is not disposed on the lower surface of the substrate 54 of the light source module 50. However, according to circumstance, the reflector 30 may be disposed on the lower surface of the substrate 54.

Further, the reflector 30 may be disposed on at least one of the side surfaces of the second grooves 24 of the light guide plate 20 and the bottom surfaces of the second grooves 24.

Here, the reflector 30 may be formed of at least one of a metal and a metal oxide, and for example, may be formed of a metal or a metal oxide exhibiting high reflectivity, such as aluminum (Al), silver (Ag), gold (Au) or titanium oxide (TiO₂).

The optical member 40 may be disposed on the upper surface of the light guide plate 20.

Here, the optical member 40 serve to diffuse light emitted through the light guide plate 20, and may have an uneven pattern disposed on the upper surface thereof to increase diffusion effects.

Further, the optical member 40 may include several layers, and the uneven pattern may be disposed on the surface of the uppermost layer or one layer.

The uneven pattern may have a stripe shape disposed along the light source modules 50.

Here, the uneven pattern includes protrusions protruding from the surface of the optical member 40, and the protrusions include first planes and second planes opposite each other. An angle between the first plane and the second plane may be obtuse or acute.

According to circumstance, the optical member 40 may include at least one sheet, i.e., may selectively include a diffusion sheet, a prism sheet, a brightness enhancement sheet, etc.

Here, the diffusion sheet serves to diffuse light emitted by the light sources, the prism sheet serves to guide diffused light to a light emission area, and the brightness enhancement sheet serves to enhance brightness of light.

FIG. 2 is a cross-sectional view illustrating a position at which the first groove of the light guide plate is disposed.

As shown in FIG. 2, the first groove 70 may be disposed on the upper surface of the light guide plate 20, and the second groove 24 may be disposed on the lower surface of the light guide plate 20.

Further, the light source module 50 is disposed within the second groove 24, and the light sources 52 of the light source module 50 may face the side surface of the second groove 24.

The first groove 70 may be disposed on the upper surface of the light guide plate 20 at one side of the second groove 24 and may be disposed between the light sources 52 of the light source module 50, simultaneously.

Here, the maximum depth of the first groove 70 means a distance d1 from the upper surface of the light guide plate 20 to the lowermost surface of the first groove 70. The maximum depth of the first groove 70 may be smaller than a distance d2 from the upper surface of the light guide plate 20 to the second groove 24.

If the maximum depth of the first groove 70 is greater than the distance d2 from the upper surface of the light guide plate 20 to the second groove 24, light is blocked by the first groove 70 and thus is not diffused to the light guide plate 20, thereby lowering brightness.

Therefore, if the depth of the first groove 70 is properly adjusted, light may be refracted by the first groove 70 and be diffused to the inside and outside of the light guide plate 20, and thus dark regions generated at areas between adjacent light sources 52 may be reduced.

For example, the depth of the first groove 70 may be about 0.1˜0.5 mm.

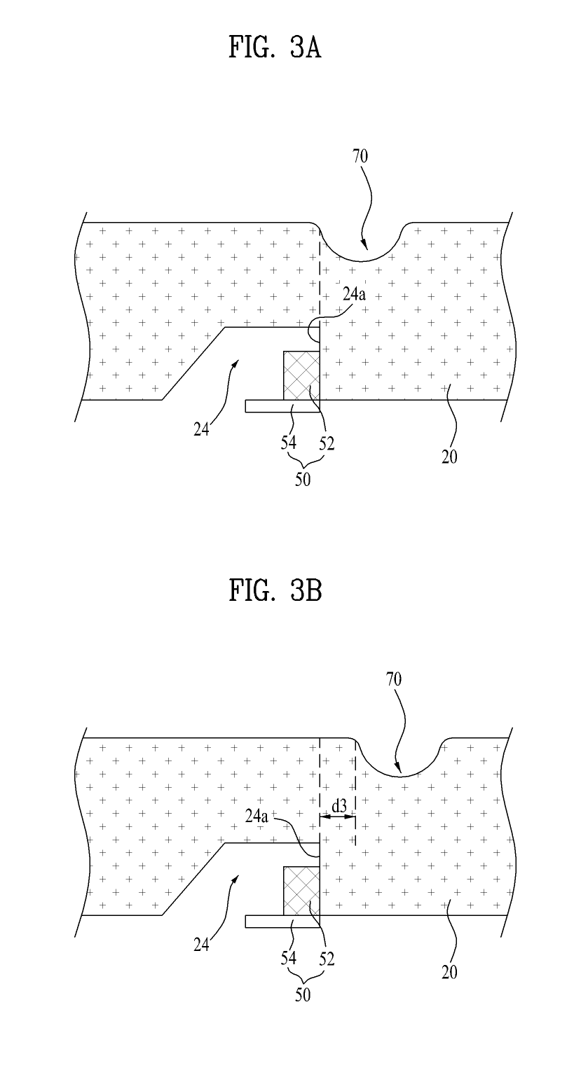

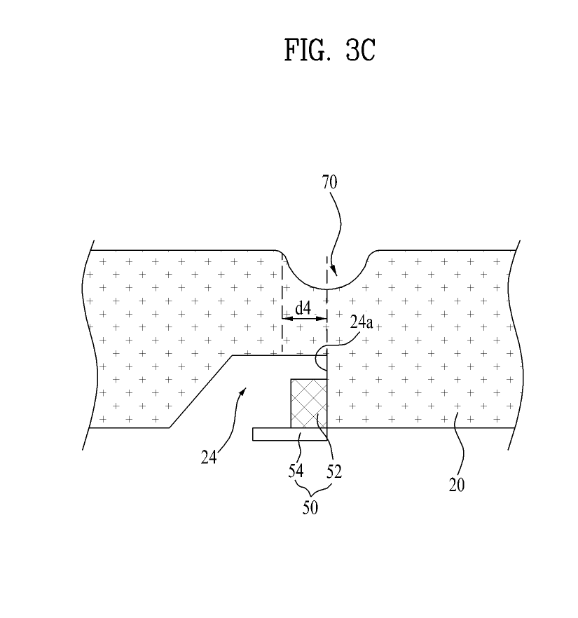

FIG. 3A to 3C are cross-sectional views illustrating position relations between first grooves and second grooves of the light guide plate.

As shown in FIG. 3A, one side end of the first groove 70 disposed on the upper surface of the light guide plate 20 may be disposed on an extension line extending from the side surface 24a of the second groove 24.

The reason for this is that dark regions generated between the light sources 52 of the light source module 50 may be generated at the area of the side surface 24a of the second groove 24.

Next, as shown in FIG. 3B, one side end of the first groove 70 disposed on the upper surface of the light guide plate 20 may be separated from an extension line extending from the side surface 24a of the second groove 24 by a designated interval d3.

The reason for this is that dark regions generated between the light sources 52 of the light source module 50 may be generated at an area separated from the area of the side surface 24a of the second groove 24.

Next, as shown in FIG. 3C, the first groove 70 disposed on the upper surface of the light guide plate 20 and the second groove 24 disposed on the lower surface of the light guide plate 20 may partially overlap each other by a designated interval d4.

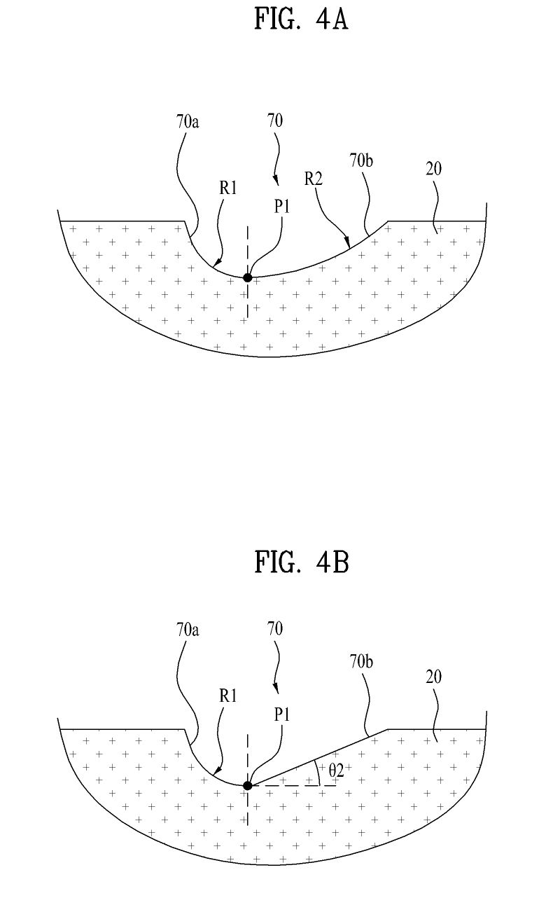

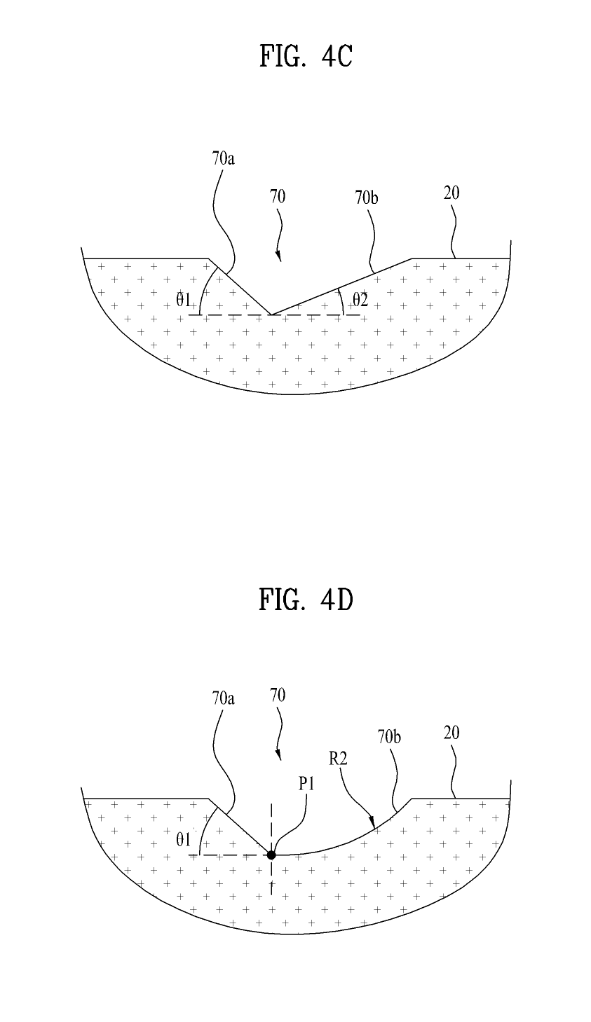

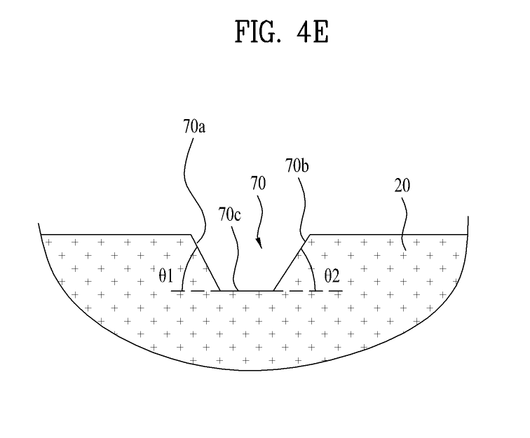

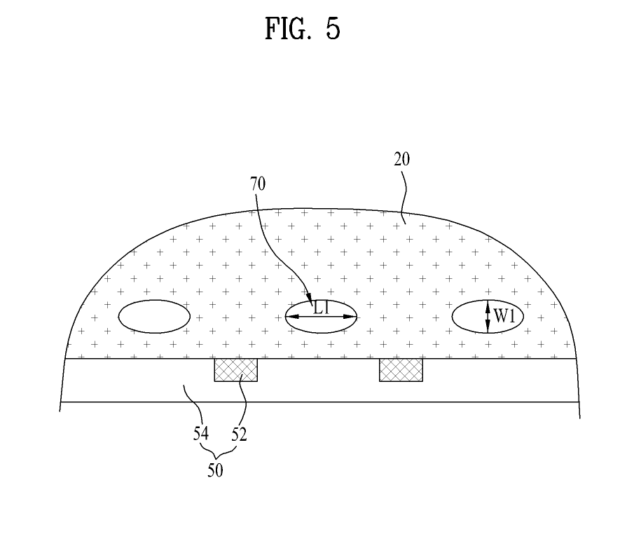

FIGS. 4A to 4E are cross-sectional views illustrating various shapes of the first grooves of the light guide plate.

As shown in FIG. 4A, the cross-section of the first groove 70 disposed on the upper surface of the light guide plate 20 may include a first inclined surface 70a and a second inclined surface 70b meeting at one point P1.

Here, the first inclined surface 70a of the first groove 70 may be a concave surface having a first curvature R1, and the second inclined surface 70b of the first groove 70 may be a concave surface having a second curvature R2.

The first curvature R1 and the second curvature R2 may be different, or be equal.

If the first curvature R1 and the second curvature R2 are different, the first curvature R1 may be greater than the second curvature R2.

Next, as shown in FIG. 4B, the cross-section of the first groove 70 disposed on the upper surface of the light guide plate 20 may include a first inclined surface 70a and a second inclined surface 70b meeting at one point P1.

Here, the first inclined surface 70a of the first groove 70 may be a concave surface having a first curvature R1, and the second inclined surface 70b of the first groove 70 may be a flat surface inclined at a designated angle θ2 with respect to the upper surface of the light guide plate 20.

Next, as shown in FIG. 4C, the cross-section of the first groove 70 disposed on the upper surface of the light guide plate 20 may include a first inclined surface 70a and a second inclined surface 70b meeting at one point P1.

Here, the first inclined surface 70a of the first groove 70 may be a flat surface inclined at a designated angle θ1 with respect to the upper surface of the light guide plate 20, and the second inclined surface 70b of the first groove 70 may be a flat surface inclined at a designated angle θ2 with respect to the upper surface of the light guide plate 20.

The first angle θ1 and the second angle θ2 may be different, or be equal.

If the first angle θ1 and the second angle θ2 are different, the first angle θ1 may be greater than the second angle θ2.

Next, as shown in FIG. 4D, the cross-section of the first groove 70 disposed on the upper surface of the light guide plate 20 may include a first inclined surface 70a and a second inclined surface 70b meeting at one point P1.

Here, the first inclined surface 70a of the first groove 70 may be a flat surface inclined at a designated angle θ2 with respect to the upper surface of the light guide plate 20, and the second inclined surface 70b of the first groove 70 may be a concave surface having a second curvature R2.

Next, as shown in FIG. 4E, the cross-section of the first groove 70 disposed on the upper surface of the light guide plate 20 may include a first inclined surface 70a and a second inclined surface 70b, and a flat surface 70c parallel with the upper surface of the light guide plate 20 may be disposed between the first and second inclined surfaces 70a and 70b.

Here, the first inclined surface 70a of the first groove 70 may be a flat surface inclined at a designated angle θ1 with respect to the upper surface of the light guide plate 20, and the second inclined surface 70b of the first groove 70 may be a flat surface inclined at a designated angle θ2 with respect to the upper surface of the light guide plate 20.

The first angle θ1 and the second angle θ2 may be different, or be equal.

If the first angle θ1 and the second angle θ2 are different, the first angle θ1 may be greater than the second angle θ2.

For example, the first and second angle θ1 and θ2 may be about 9˜89 degrees.

FIG. 5 is a plan view illustrating the positions of the first grooves of the light guide plate.

As shown in FIG. 5, the first grooves 70 disposed on the upper surface of the light guide plate 20 may be separated from each other at a designated interval, and be disposed in front of the light source module 50.

The respective first grooves 70 may be disposed between the light sources 52 of the light source module 50.

Here, the length L1 of the first groove 70 may mean a distance between both ends of the first groove 70 disposed in the first direction (the direction in which the light sources 52 of the light source module 50 are arranged). The length L1 of the first groove 70 may be about 3˜7 mm.

Further, the width W1 of the first groove 70 may mean a distance between both ends of the first groove 70 disposed in the second direction perpendicular to the first direction. The width W1 of the first groove 70 may be about 1˜4 mm.

The length L1 and the width W1 of the first groove 70 may be smaller than the distance between the light sources 52 of the light source module 50.

Therefore, the length L1 and the width W1 of the first groove 70 may be varied according to the distance between the light sources 52 of the light source module 50.

When the first grooves 70 are disposed at dark regions generated between adjacent light sources 52, as described above, light is refracted by the first grooves 70 and thus the dark regions may be reduced, and uniform brightness may be provided.

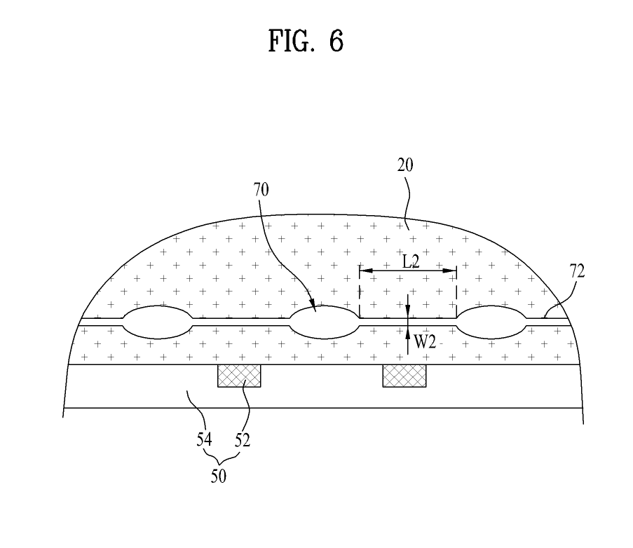

FIG. 6 is a plan view illustrating the positions of third grooves of the light guide plate.

As shown in FIG. 6, third grooves 72 may be additionally disposed between adjacent first grooves 70 of the light guide plate 20.

Here, the third grooves 72 may be disposed at positions corresponding to the respective light sources 52 of the light source module 50.

Further, the third grooves 72 may be connected to the adjacent first grooves 70.

The length L2 of the third groove 72 means a distance between adjacent first grooves 70. The length L2 of the third groove 72 may be smaller than the length L1 of the first groove 70 and be greater than the length of the light source 52.

Further, the width W2 of the third groove 72 means a distance between both ends of the third groove 72 in a direction perpendicular to the lengthwise direction of the third groove 72. The width W2 of the third groove 72 may be smaller than the width W1 of the first groove 70.

The depth of the third groove 72 may be equal to the depth of the first groove 70, or may be different from the depth of the first groove 70 according to circumstance.

For example, the depth of the third groove 72 may be smaller than the depth of the first groove 70.

Here, a ratio of the depth of the third groove 72 to the depth of the first groove 70 may be about 1:1.5˜3.

The reason why the third grooves 72 are disposed, as described above, is that, since adjacent first grooves 70 may cause a brightness difference, in order to provide uniform brightness, the brightness difference between the first grooves 70 needs to be reduced.

Therefore, by forming the third grooves 72 between the first grooves 70, the brightness difference may be prevented and dark regions generated in front of the light sources 52 may be reduced.

Further, the third groove 72 may be separated from an extension line extending from one side of the second groove 24 so as to prevent overlap of the third grooves 72 with the second grooves 24 disposed on the lower surface of the light guide plate 20.

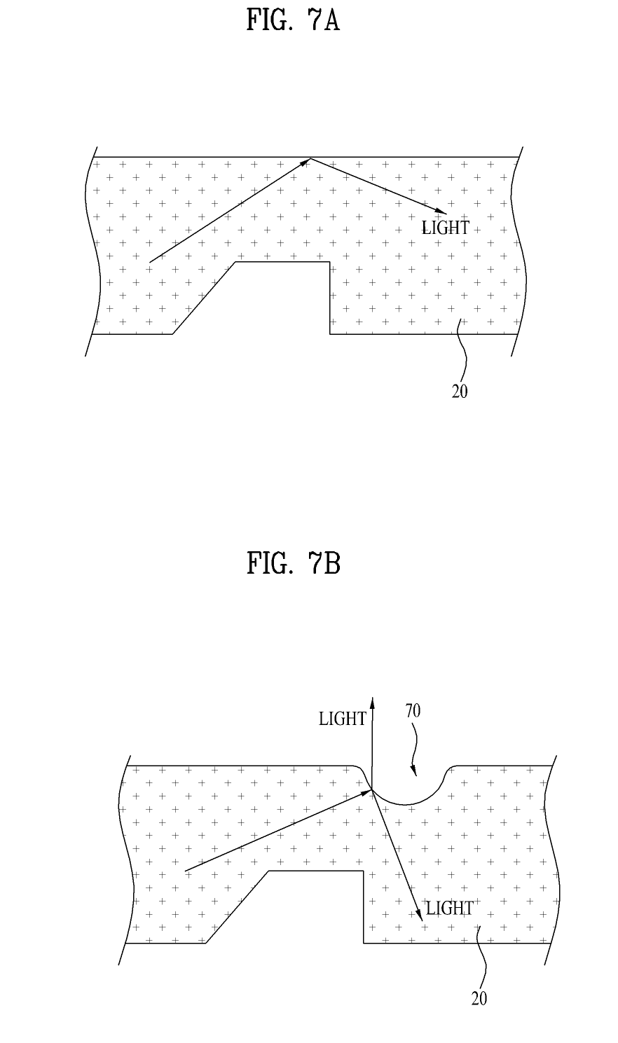

FIGS. 7A and 7B are views illustrating refraction of light according to presence and absence of the first groove of the light guide plate.

FIG. 7A illustrates refraction of light if no first groove 70 is disposed on the upper surface of the light guide plate 20, and FIG. 7B illustrates refraction of light if the second groove 24 is disposed on the upper surface of the light guide plate 20.

As shown in FIG. 7A, if no first groove 70 is disposed on the upper surface of the light guide plate 20, light diffused to the inside of the light guide plate 20 is reflected by the upper surface of the light guide plate 20 and is then returned to the inside of the light guide plate 20.

Therefore, dark regions generated between the light sources may remain.

However, as shown in FIG. 7B, if the first groove 70 is disposed on the upper surface of the light guide plate 20, a portion of light diffused to the inside of the light guide plate 20 may be refracted to the outside of the light guide plate 20 by the first groove 70 disposed on the upper surface of the light guide plate 20, and the remaining portion of light may be returned to the inside of the light guide plate 20.

Therefore, dark regions generated between the light sources may be reduced by light refracted to the outside of the light guide plate 20 by the first groove 70.

As described above, the embodiments form grooves at dark regions on the upper surface of the light guide plate, and thus reduce dark regions, thereby being capable of providing a backlight unit having uniform brightness.

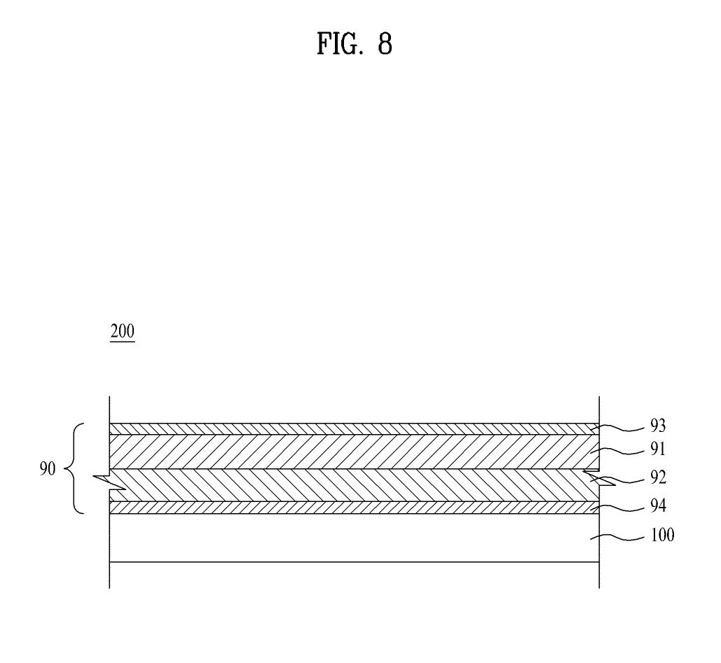

FIG. 8 is a cross-sectional view illustrating a display module having a backlight unit in accordance with one embodiment.

As shown in FIG. 8, a display module 200 includes a display panel 90 and a backlight unit 100.

The display panel 90 includes a color filter substrate and a thin film transistor (TFT) substrate 92 disposed opposite each other and bonded to each other to maintain a uniform cell gap, and a liquid crystal layer (not shown) may be interposed between the two substrates 91 and 92.

The color filter substrate 91 includes a plurality of pixels including red (R), green (G) and blue (B) sub-pixels, and generates an image corresponding to red, green or blue if light is applied to the color filter substrate 91.

Although the pixels may include red (R), green (G) and blue (B) sub-pixels, the embodiment is not limited thereto and red (R), green (G), blue (B) and white (W) sub-pixels may form one pixel.

The TFT substrate 92 includes switching elements, and may switch pixel electrodes (not shown).

For example, a common electrode (not shown) and the pixel electrodes may change arrangement of molecules of the liquid crystal layer based on a designated voltage applied from the outside.

The liquid crystal layer may include a plurality of liquid crystal molecules, and arrangement of the liquid crystal molecules is changed due to a voltage difference between the pixel electrodes and the common electrode.

Thereby, light generated from the backlight unit 100 may be incident upon the color filter substrate 90 in response to change of molecular arrangement of the liquid crystal layer.

Further, an upper polarizing plate 93 and a lower polarizing plate 94 may be disposed on the upper surface and the lower surface of the display panel 90, and more particularly, the upper polarizing plate 93 may be disposed on the upper surface of the color filter substrate 91 and the lower polarizing plate 94 may be disposed on the lower surface of the TFT substrate 92.

Although not shown in the drawings, gate and data driving units generating driving signals to drive the display panel 90 may be provided on the side surface of the display panel 90.

As shown in FIG. 8, the display module 200 may be disposed by disposing the backlight unit 100 close to the display panel 90.

For example, the backlight unit 100 may be fixed to the lower surface of the display panel 90, more particularly be attached to the lower polarizing plate 94, and for this purpose, an adhesive layer (not shown) may be disposed between the lower polarizing plate 94 and the backlight unit 100.

By attaching the backlight unit 100 to the display panel 90, as described above, the overall thickness of the display apparatus is reduced, and thus the external appearance of the display apparatus may be improved. Further, additional structures to fix the backlight unit 100 are removed, and thus the structure and manufacturing process of the display apparatus may be simplified.

Further, by removing a space between the backlight unit 100 and the display panel 90, malfunction of the display apparatus or deterioration of the quality of a displayed image due to invasion of foreign substances into the space may be prevented.

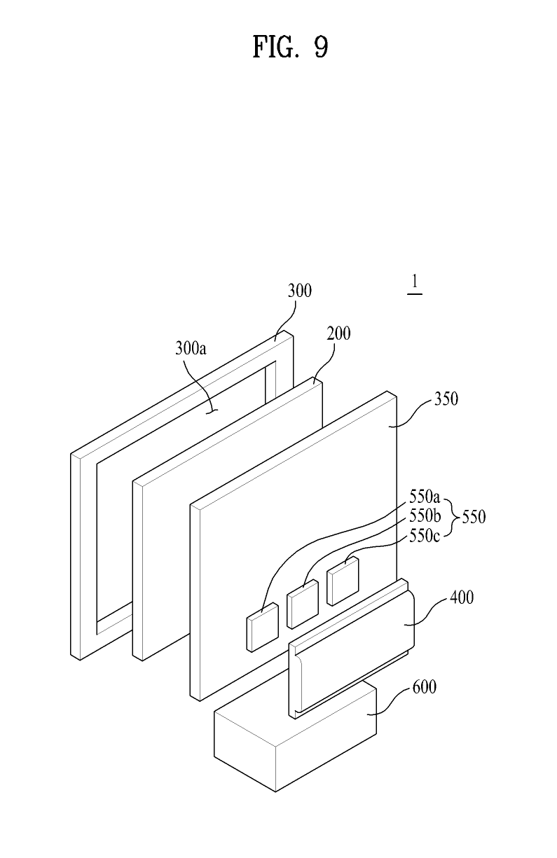

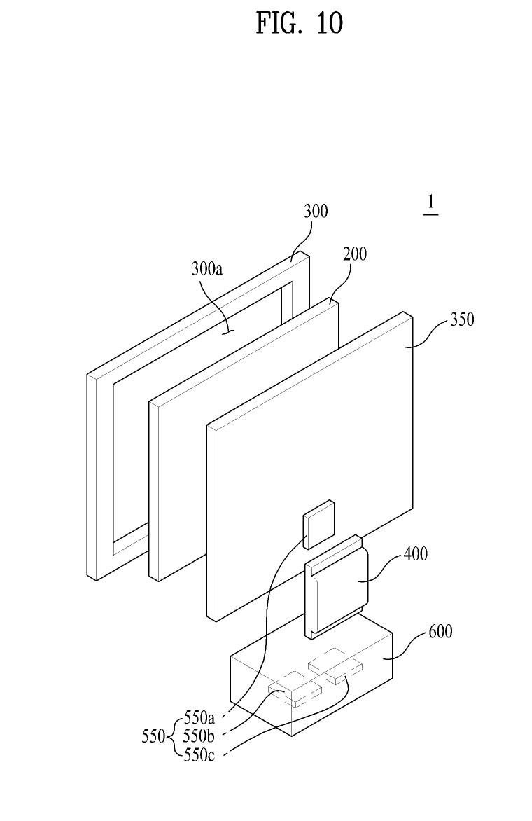

FIGS. 9 and 10 are views respectively illustrating display apparatuses in accordance with embodiments.

First, as shown in FIG. 9, a display apparatus 1 includes a display module 200, a front cover 300 and a back cover 350 surrounding the display module 200, a driving unit 550 provided on the back cover 350, and a driving unit cover 400 surrounding the driving unit 550.

The front cover 300 may include a front panel (not shown) formed of a transparent material transmitting light. The front panel which is separated from the display module 200 at a designated interval protects the display module 200 and transmits light emitted from the display module 200, thereby allowing an image displayed on the display module 200 to be seen from the outside.

Further, the front cover 300 may be a flat plate without a window 300a.

In this case, the front cover 300 may be formed of a transparent material transmitting light, for example, of injection molded plastic.

If the front cover 300 is a flat plate, a frame may be removed from the front cover 300.

The back cover 350 may be connected to the front cover 300 to protect the display module 200.

The driving unit 550 may be disposed on one surface of the back cover 350.

The driving unit 550 may include a driving control unit 550a, a main board 550b and a power supply unit 550c.

The driving control unit 550a may be a timing controller, i.e., a driver to control operation timing of respective driver ICs of the display module 200, the main board 550b may be a driver to transmit a V-sync, an H-sync and R, G and B resolution signals to the timing controller, and the power supply unit 550c may be a driver to apply power to the display module 200.

The driving unit 550 may be provided on the back cover 350 and be surrounded by the driving unit cover 400.

The back cover 350 may be provided with a plurality of holes through which the display module 200 and the driving unit 550 are connected to each other, and a stand 600 to support the display apparatus 1 may be provided.

Next, as shown in FIG. 10, the driving control unit 550a of the driving unit 550 may be provided on the back cover 350, and the main board 550b and the power supply unit 550c of the driving unit 550 may be provided on the stand 600.

Further, the driving unit cover 400 may surround only the driving control unit 550a provided on the back cover 350.

Although the embodiments describe the main board 550b and the power supply unit 550c as being separately provided, the main board 550b and the power supply unit 550c may be integrated into one board.

Another embodiment may implement a display apparatus, an indication apparatus or an illumination system including the light guide plate having the first and second grooves and the light source modules described in accordance with the above-described embodiments, and, for example, the illumination system may include a lamp or a streetlight.

Such an illumination system may be used as an illumination lamp which concentrates light emitted from plural LEDs, particularly used as a lamp (down light) which is embedded in the ceiling or the wall of a building and is installed to expose an opening of a shade.

As is apparent from the above description, a backlight unit and a display apparatus using the same in accordance with one embodiment form grooves at areas where dark regions are generated, thereby reducing the dark regions and thus allowing the backlight unit to have uniform brightness.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
a light guide plate including first and second grooves; and
light source modules disposed within the second grooves, wherein:
the first grooves are disposed on the upper surface of the light guide plate, and the second grooves are disposed on the lower surface of the light guide plate; and
the first grooves are disposed between light sources of the light source module.

2. The backlight unit according to claim 1, wherein one side end of each of the first grooves is disposed on an extension line extending from the side surface of each of the second grooves.

3. The backlight unit according to claim 1, wherein one side end of each of the first grooves is separated from an extension line extending from the side surface of each of the second grooves by a designated interval.

4. The backlight unit according to claim 1, wherein the first grooves and the second grooves partially overlap with each other.

5. The backlight unit according to claim 1, wherein the cross-section of each of the first grooves includes a first inclined surface and a second inclined surface meeting at one point.

6. The backlight unit according to claim 5, wherein the first inclined surface is a concave surface having a first curvature, the second inclined surface is a concave surface having a second curvature, and the first curvature and the second curvature are different.

7. The backlight unit according to claim 5, wherein the first inclined surface is a flat surface inclined at a first angle with respect to the upper surface of the light guide plate, the second inclined surface is a flat surface inclined at a second angle with respect to the upper surface of the light guide plate, and the first angle and the second angle are different.

8. The backlight unit according to claim 5, wherein one of the first and second inclined surfaces is a concave surface having a designated curvature, and the other of the first and second inclined surfaces is a flat surface inclined at a designated angle with respect to the upper surface of the light guide plate.

9. The backlight unit according to claim 1, wherein the cross-section of each of the first grooves includes a first inclined surface and a second inclined surface, and a flat surface parallel with the upper surface of the light guide plate is disposed between the first and second inclined surfaces.

10. The backlight unit according to claim 1, wherein the first grooves have a height of 0.1˜0.5 mm.

11. The backlight unit according to claim 1, wherein the maximum depth of the first grooves is smaller than a distance from the upper surface of the light guide plate to the second grooves.

12. The backlight unit according to claim 1, wherein the length of the first grooves is a distance between both ends of the first grooves disposed in a first direction, the width of the first grooves is a distance between both ends of the first grooves disposed in a second direction perpendicular to the first direction, and the length and width of the first grooves are smaller than a distance between the light sources of the light source module.

13. The backlight unit according to claim 12, wherein the length of the first grooves is 3˜7 mm, and the width of the first grooves is 1˜4 mm.

14. The backlight unit according to claim 1, wherein the light guide plate further includes third grooves disposed between the adjacent first grooves.

15. The backlight unit according to claim 14, wherein the third grooves are disposed corresponding to the respective light sources of the light source module.

16. The backlight unit according to claim 14, wherein the length and width of the third grooves are smaller than the length and width of the first grooves.

17. The backlight unit according to claim 14, wherein the depth of the third grooves is smaller than the depth of the first grooves, and a ratio of the depth of the third grooves to the depth of the first grooves is 1:1.5˜3.

18. The backlight unit according to claim 14, wherein each of the third grooves is separated from one side of each of the second grooves by a designated interval.

19. The backlight unit according to claim 14, wherein the length of the third grooves is greater than the length of the respective light sources of the light source module.

20. A display apparatus comprising:
a display panel; and
a backlight unit irradiating light onto the display panel,
wherein the backlight unit includes:
a light guide plate including first and second grooves; and
light source modules disposed within the second grooves, wherein:
the first grooves are disposed on the upper surface of the light guide plate, and the second grooves are disposed on the lower surface of the light guide plate; and
the first grooves are disposed between light sources of the light source module.
